(19) United States
(12) Patent Application Publication
(10) Pub. No.: US 2005/0043940 A1
(43) Pub. Date: Feb. 24, 2005

(54) Preparing a data source for a natural language query

(76) Inventor: Marvin Elder, Carrollton, TX (US)

Correspondence Address: Steven Thrasher, 391 Sandhill Dr., Richardson, TX, 75080, US

(21) Appl. No.: 10/923,164

(22) Filed: Aug. 20, 2004

Related U.S. Application Data
(60) Provisional application No. 60/496,442, filed on Aug. 20, 2003.

(51) Int. Cl. G06F 17/27

(52) U.S. Cl. 704/9

(57) ABSTRACT

The invention teaches preparing data sources for a natural language query. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CROSS REFERENCE TO RELATED APPLICATIONS

The invention is a continuation in part of, is related to, and claims priority from U.S. Provisional Patent Application No. 60/496,442, filed on Aug. 20, 2003, by Marvin Elder, and entitled NATURAL LANGUAGE PROCESSING SYSTEM METHOD AND APPARATUS.

### TECHNICAL FIELD OF THE INVENTION

The invention relates generally to matching data in data sources with data queries.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

The ability to quickly and effectively access data is important to individuals, business and the government. Individuals often use spreadsheets to access specific data regarding items such as checking accounts balances, and cooking recipes. Businesses' thrive off of effective access of data of all kinds including, shipping delivery, inventory management, financial statements, and a world of other uses. In addition to managing revenue flow, the government utilizes data access for purposes ranging from artillery tables, to fingerprint data bases, to terrorist watch lists, and the mountain of statistics and information compiled by the census bureau.

Of course, there are literally millions different kinds of data source accesses known by persons in their every day lives, as well as by professionals in data storage and access arts. Unfortunately, it frequently takes some degree of familiarity with database searching structure to effectively access data in a data source, such that there are actually specialists in searching various data sources for specific types of information. Accordingly, there is a need for systems, methods, and devices that enable a person who does not have formal training to effectively search data sources.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 illustrates a natural language request algorithm.

FIG. 2 shows a natural automated answer delivery algorithm.

FIG. 3 is an enable natural language algorithm.

FIG. 4 illustrates a natural language linking algorithm.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, for example, and so a use of the word tacking invokes stapling, gluing, for example, and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in § 112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

Description of the Drawings

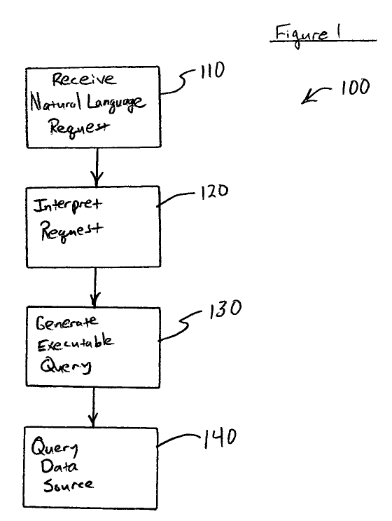

FIG. 1 illustrates a natural language request algorithm (NLR Algorithm) 100 that is preferably performed on a dataset that has already been through Semantification (discussed below). The NLR algorithm 100 begins with a receive natural language request 110. A NLR generally comprising text (either written or vocalized), where the text generally comprises phrases having words. The request may be in English, Spanish, Japanese, French, German, or any other language for which rules sets are available. What distinguishes a NLR from a typical data based structured query is that a NLR is made in the users' vernacular language—that a query may be formulated without strict adherence to definitions and/or rules of grammar.

Accordingly, a person without any formal database training should be able to make a query that is interpretable and results in the delivery in of data and response to that query as described herein. Of course, it should be understood that other means of receiving a NLR other than type written text or vocalized text, such as through object oriented or icon driven query, touch tone or touch tone responses across a telephone network, and equivalents including those known and unknown. Next, in an interpret request act 120, the NLR algorithm 100 classifies each word according to a rule set based on language rules that identify parts of speech. For example, words may be identified as verbs, subject, and direct or indirect objects. One system that accomplishes this task, sometimes referred to as parsing, is the Sementra™ discussed below.

Following the interpret request act 120, the NLR algorithm 100 proceeds to a generate executable query act 130. The generate executable query act 130 creates a query statement readable by a standard structured query language or other structured data base system based on the association of each word with a part of speech. Accordingly, the natural language query or question entered by a user is best converted to structured code that can formally query a data base or other data source, such as a spreadsheet, indexed text, or other equivalent data storage system, known or unknown. Then, when a query data source act 140, the structured data base query is sent to the data source. If data matching the data query exists in the data source, that data is extracted from the data source. The extracted data is defined as a result set.

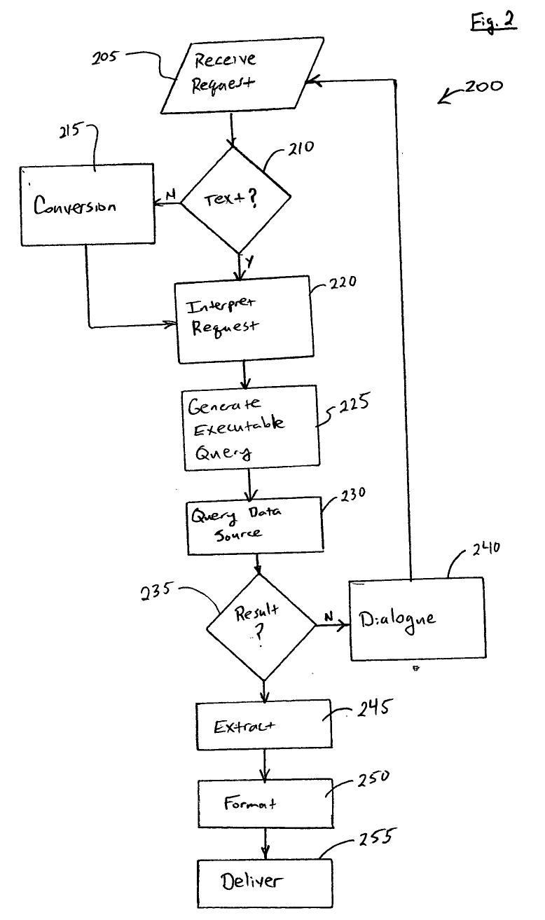

FIG. 2 shows a natural language automated answer delivery algorithm (NLA algorithm) 200. The NLA algorithm 200 performs the task identified in the receive NLR 110 of the NLR algorithm 100. Then, the NLA algorithm 200 proceeds to a text query 210 which checks the received request to determine if a conversion from voice to text or touch-tone to text or icon to text or other conversion is necessary. If the text query 210 determines that the received request does not consist of written words, the NLA algorithm 200 proceeds along the no path to a conversion at 215. In the conversion act 215 the received request is converted into a text request. For example, an icon of a ship may be converted into the word ship, a touch-tone that sounds as 3 may be converted into service department, or the vocalized query may be converted to text through voice to text technology.

If the text query 210 determines that no conversion is necessary the NLA algorithm 200 proceeds along the yes path to an interpret request act 220. The interpret request act 220 is also reached following the conversion act 215. The interpret request act 220 performs the task of the interpret request act 120 of the NLR algorithm 100 before proceeding to a generate executable query act 225, which mirrors the generate executable query act 130 of the NLR algorithm 100. Interpreting the request may also comprise pursing the text by referencing a Symantec phrase or repository, and may locate noun phrases in a conceptual object repository. Further a user may add references in a Semantic phrase repository or in a conceptual object repository to aid in a full and accurate interpretation of the request.

Then, the structured query is sent to a data source in a query data source act 230 in an attempt to find the desired information. Of course, the information may be present, but the natural language query provided may be too ambiguous or broad or alternatively too narrow to pin point that information. Accordingly, following the query data source act 230 a result query 235 is performed. The result query 235 prompts the user to see if the result generated matches the data sought. If the result generated (including no result at all) is not what was sought, the NLA algorithm 200 proceeds along a no path to a dialogue at 240.

The dialogue 240 prompts the user to enter additional or different query requests in an attempt to provide better search results. In one embodiment, the request will prompt a user regarding whether or not one word is equivalent to another word, and/or one word is a sub-set or super-set of a word or phrase. However, if in the result query 235 results are received, then the NLA algorithm 200 proceeds along the yes path to an extract act 245. The extract act 245 copies the data from the data sources and presents that data to the user in a user identifiable format that may include written text, audible report, or icons, for example. In addition, the NLA algorithm 200 may also format the search results in either a pre defined or in a user selective manner.

For example, a data report may be formatted as a cable, or the data may be converted into a natural language response. Of course many different forms of presenting data are available, and equivalents known and unknown are incorporated within the scope of the invention. Then, following the formatting of the search results, the search results are delivered to the user making the query in a deliver act 255.

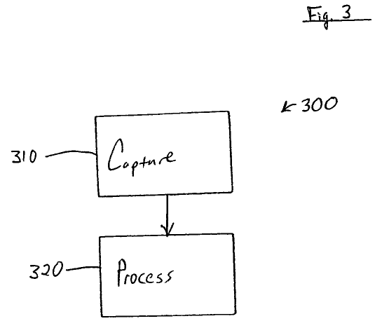

FIG. 3 shows an enabled natural language algorithm (ENL algorithm) 300. The ENL algorithm 300 begins with a capture act 310 in which the metadata associated with a target data source, such as a database spreadsheet XML file a web service or an RSS type web service, for example, is captured. The metadata in one embodiment defines a target concept model. Then, in a process act 320 the ENL algorithm 300 processes the target concept model to enable data base searching through natural language queries. Capturing may include the process of building a concept data model by generating a first concept object from a data source, a link that associates a first element to a second element in a logical association, and a natural language identifier that uniquely names the target concept model via at least one natural word.

Target concept models may comprise entities, and each entity should be logical mapped to a table in a target data source. In addition, each entity comprises at least one attribute and each attribute should be logically mapped to one column in the table.

The target concept model may also define a subject area. While a subject area includes one or more logical views, Similarly, a logical view includes at least two entities. Further, each entity and each attribute should be assigned a unique natural language name.

Processing includes generating a semantic phrase that associates at least two entities, or at least two attributes. The semantic phrase is then stored in a semantic phrase or repository. In one embodiment, a second semantic phrase may be linked to the first semantic phrase in a parent child relationship (the parents semantic phrase already exists in a semantic phrase repository). In addition, processing may add a new concept model layer to an existing concept model repository, and also may add one or more semantic phrases to an existing semantic phrase repository where the two repositories are interdependent. The two semantic phrase repositories are structured and organized such that a natural language request for information from a target data base can be interpreted by a natural language processor and automatically translated into a data query that returns a precise answer.

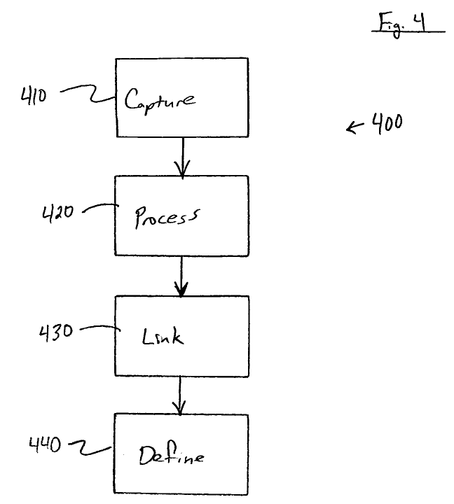

FIG. 4 illustrates a natural language linking algorithm (NLL algorithm) 400. In addition to capturing 410 and processing 320 the NLL algorithm 400 also defines a logical relationship between a pair of entities and a target concept model in a linking act 430. In one embodiment this is based on metadata. In an alternative embodiment the linking of two entities is based upon a logical relationship that includes ‘is-a’ ‘has-a’ and ‘member-of’ relationships.

Then in a define act 440 a concept object is defined based on conditions that make the concept object unique. In addition, the define act 440 may define a new attribute as a logical equivalent of a pre-defined attribute associated with an entity.

Alternative Exemplary Embodiment

1.

Natural Language Processing: Overall Architecture and Process

Overview—Natural Language Processing (NLP) software.

This software comprisess of several modules, described below. Collectively, these modules constitute software, called “Vobots NLP” or just “NLP” (NLP refers to a software product: a set of software modules. Where used, the term ‘Vobots’ by itself refers to a particular type of ‘software agent’ within the whole collection of NLP's collaborative software modules. Thus Vobots are ‘personal agents’ which act in behalf of a user to get information or to conduct ‘vocal transactions’).

Vobots NLP is a ‘round-trip request handling’ product. Vobots NLP modules deduce the meaning of a natural language request or command, and either retrieve an answer or carry out a transaction in behalf of a requester. In its most common usage, Vobots NLP converts a request for information into SQL queries, which extract answers from public or private databases. Then another Vobots NLP software module formats and returns the answer to the requester. The software modules which comprise the functionality of NLP are:
Vobots Semantra™ (Natural Language Understanding Engine)
Vobots Request Manager/Router
Vobots Data Mapper/SQL Generator software agent
Vobots Answer Set Formatter
   Overall Architecture and Process

The most extensive and most common ‘round-trip process’ for Vobots NLP is in handling natural language requests for information. Attached herewith as Claim #1—Exhibit A is a Act-by-Act explanation of the sequence of ‘round trip’ actions, from the time a User issues an information request through to returning the answer to the User. Claim #1—Exhibit B is a diagrammatic view of the overall process.

In these exhibits, it is clear that the Vobots Semantra™ NLU parses the user information request (performed on the Vobots Application Server), and then decouples the rest of the process by sending parsed requests as encrypted XML packets to a Vobots Request Manager/Router (a completely separate software module from the Semantra™ software module). The Semantra™ Natural Language Understanding (NLU) Engine is described in detail in a separate sub-document, as discussed below. This software module is a ‘core’ product for the Vobots NLP, in that it is the module which performs the natural language understanding function.

Once the Vobots Request Manager/Router receives an encrypted XML packet set, it then routes the XML packets across the internet or Virtual Private Network to one or more Vobots Data Mapper/SQL Generator software agents, which usually reside on a computer physically housed at a customer's site where corporate databases maintain data needed to answer the user's information request.

The Vobots Data Mapper/SOL Generator is, like Semantra™, a core module in the Vobots NLP architecture. This module maps Subject Area elements (called ‘Information Objects’) to actual database tables and columns, and then dynamically generates and executes SQL queries against targeted databases. Once the request results are retrieved from the targeted data source(s) by the Data Mapper/SQL Generator agent software, answer sets are sent back to the Vobots Request Manager/Router module.

An important feature of the Vobots NLP architecture (a feature described in Act 5 in the Act-by-Act sequence exhibits) is that a single user information request or command may be ‘multicast’ to more than one targeted database. In such case, the Vobots Request Manager/Router is alerted to watch for ‘candidate answer sets’ coming back from the targeted database sites; when all such answer sets arrive, this software module may perform post-processing functions according to pre-defined rules and conditions.

Within Overall Vobots NLP: ‘Distributed Natural Language Processing’

Vobots NLP has overall processes distributed logically, asynchronously and/or physically among software modules and software agents. In a unique manner, Vobots NLP technology decouples the actual query construction into a ‘natural language request understanding’ component and a ‘data extraction’ component.

By decoupling the Natural Language Understanding (NLU) process from the actual SQL generation and extraction process, Vobots NLP's architecture has many advantages over competitive products. These advantages include a) greater semantic interpretation accuracy, b) better scalability for simultaneous user request handling, c) ability to multicast queries (see section above), and d) time and cost savings in readying customer databases for natural language queries. The innovation of distributed NLP is fundamental to Vobots, Inc.'s overall process claim, made herein. The details of this novel feature are shown in Exhibit C. Distributed Natural Language Query Processing, appended to this document.

Other Innovations

Individual software modules or functional processes within the overall process and architecture (see brief descriptions above) include:
Vobots Semantra™ NLU (Natural Language Understanding) Engine
Vobots Data Mapper/SQL Generator software agent
Vobots Request Manager/Router

One may “vocalize” a company's databases so that natural language requests can be executed against them. Each vocalized corporate database is mapped against a previously constructed ‘subject area model’: usually a template schema of the company's industry or of a business process in which the client company is engaged. In some cases, a client company has non-relational ‘legacy corporate databases’ which it wants to vocalize. In one embodiment, a transformed relational database is the ‘subject area’ or ontology for the non-relational database.

A. Vobots NLP Information Request-Handling Operations Sequence

The accompanying Vobots Request-Handling Operations Diagram illustrates the sequential Acts of Vobots request handling operations ‘in action’, as a user request progresses from the user to each Vobots NLP software module in a series of request-handling operations. The Vobots NLP software modules involved in the information request-handling operations are:
Vobots Semantra™ NLU (Natural Language Understanding) Engine
Vobots Request Manager/Router
Vobots Data Mapper/SQL Generator software agent
Vobots Answer Set Formatter

Below is an explanation of the sequence of ‘round trip’ actions, from the time a User issues an information request through to returning the answer to the User. The use of the term Act below does not invoke Act-plus-function language.

Act 1a. User types in an information request -or-

Act 1b.1 User issues a vocal information request by speaking into a cell-phone, PC, microphone, or voice-enabled wireless device.

Act 1b.2. Vocal request is converted from speech to text through a ‘Speech to Text’ software package (such as IBM™ Via Voice™).

Act 2. Text request sent to Vobots' Application Server, where the information request is logged and opened as a session to the Vobots Semantra™ NLU Engine for Natural Language processing.

Act 3. In parsing the information request, Semantra™ NLU consults its subject area metadata repository and its Semantics Knowledge Base.

Act 3a. If Semantra™ does not fully understand the information request, or if information needed is missing from the request, a ‘Clarification Dialog’ is engaged with the user to clarify and/or complete the information request.

Act 4. Once the information request is understood by the NLU, the information request session is closed and the parsed request is packaged as an encrypted XML packet and sent to the Vobots Request Manager/Router software agent, where the request is logged and is routed to one or more targeted, ‘vocalized’ Databases.

Act 5. The Vobots Request Manager/Router determines which vocalized target database(s) can answer all or part of the information request, and routes the X packet to the customer site(s) at which the targeted databases reside. (Note that one request can by ‘multicast’ to any number of targeted database sites. Each site processes the request against those targeted databases at only that site, so in effect ‘parallel processing’ of the same query can take place).

Act 6. At the customer site, a Vobots Data Mapper/SQL Generator software agent decrypts the XML packet. The software agent's Data Mapper maps the Subject Area Information Objects in the information request to the particular targeted database's tables and columns.

Act 7. The Vobots software agent's SQL Generator module dynamically determines the relational navigation to the mapped tables and columns and generates one or more SQL queries against the targeted database.

Act 8. The answer sets streaming from the target database are encrypted and returned to the Vobots Request Manager/Router software agent.

Act 9. The Vobots Request Manager/Router manages Request Answer Sets according to data-driven business rules, conditions and functions, including:

merging answer sets (perhaps with new SQL queries), sorting answer sets, selecting the best answer’ from candidate answer sets, and other post-processing functions).

Act 10. The Vobots Request Manager/Router routes the encrypted answer sets to the Vobots Answer Set Formatter.

Act 11. The Vobots Answer Set Formatter formats the answer sets according to stored business rules pertaining to the user's device type, and sends the formatted answer set(s) back to the user device (or to the user's browser if he or she is requesting information over the internet).

Act 12. User acknowledges the answer (affirms that answer is satisfactory or registers message describing alleged invalidity of answer). If the user wants to continue the information request session, he or she initiates a follow-up request or directive.

B. Distributed Natural Language Query Processing

One innovation in the processing of a User's Natural Language Request for Information is ‘decoupling’ the process, so that the actual Natural Language Understanding part of the process is separated physically and asynchronously from the part of the process which generates SQL or other data extraction methods to actually extract answers from targeted databases. Before describing how the Vobots Natural Language Processing (NLP) process is decoupled, some definitions are in order.

The Semantra™ Natural Language Engine (Semantra™) is the software module responsible for parsing the user's natural language information request, through its Natural Language Understanding (NLU) module.

Semantra™ maintains meta-repositories of hierarchical subject areas (ontologies). Each subject area comprisess of ‘entities’ and ‘entity attributes’, named in commonly used, regular every-day terms that a normal user would use to describe objects in that subject area. These entities are called ‘Information Objects’ (“IOs). Some novel decoupling features of the Vobots NLP are accomplished in successive acts, explained below.

1) As each user information request is processed by the Semantra™ Natural Language Understanding (NLU) Engine, this NLU module examines each word or phrase (group of words) in the user's sentence to find a match in its IO meta-repository (or to find a match in a dimension IO value list). Matching IOs are captured as ‘select’ nouns, while ‘IO values’ are recognized and captured as ‘where conditions/values’ for later query processing. This represents the ‘semantics’ part of the query construction.

2) After Semantra™'s NLU has successfully parsed and identified Subject Area IOs, these IO entities, attributes and values are used to construct a set of ‘parsed frame-slot objects’. Semantra™ sends these frame-slot objects to the Vobots SQL Generator, a software module separated in usage by time (and often physically separated) from the Semantra™ NLU. The SQL Generator then dynamically performs two functions:
(a) it relies on a set of ‘relational navigation algorithms’ to complete the query construction by adding clauses such as the ‘join’ clause, the ‘group by’ clause, the ‘order by’ clause, for example. These relational navigation algorithms represent an essential part of Vobots, Inc.'s intellectual property assets, for which patent applications will be filed under separate cover.
(b) having completed the construction of the SQL query, the SQL Generator executes this query against targeted database tables to searched for ‘facts’: values of Entity attribute columns which map to parent subject area IOs.

This decoupling of Natural Language Processing is an important advancement in the field of Natural Language, since it allows the Vobots technology to handle a much higher volume of natural language requests than its competitors' products.

2. Overall Semantra™ Process Acts

The overall Semantra™ process includes three (3) separate functions, working in concert:

A. Semantra™ NLU.

B. Heuristics function: adding Semantic objects and Information Objects to Semantra™'s meta-repositories.
a. Automatically adding Semantic objects
b. Prompting User/SME through User Clarification Dialog:
   i. for Synonyms, new Semantic Phrase
   ii. for new Information Object

C. Semantra™'s Reasoning function.

The overall Semantra™ process for disambiguating a user's natural language request is shown in Actwise fashion below.

1. Pre-NLU functions:
1.a. Compile lists of ‘candidate matching objects’, restricted to ‘highest Subject Area’ and all of its (more generic) parent Subject Areas
   1.a.1. Compile list of Candidate Subject Area IOs
   1.a.2. Compile list of Candidate Dimension IO Values
1.b. Tokenize user request into sentences, then into list of ‘Unresolved Phrase Tokens’

2. NLU functional Acts:
2.a. pre-parsing functions:
   2.a.1. Construct Phrase Structure Tree (S-Tree), determining Part-of-Speech (POS) relationships (e.g., Verb Phrases associations with Noun Phrases, for example)
2.b. NLU Outer Parsing loop:
   2.b.1. (Before Inner Parsing loop):
      2.b.1.1. Select appropriate Sentence Grammar, based on S-Tree phrase market evaluation
      2.b.1.2.

Call Reasoning functions to increase likelihood of ‘reasonable interpretation’
2.c. NLU Inner Parsing Loop (until all phrase tokens resolved):
   2.c.1. Inspect next Chunk against various Phrase Token Handlers (e.g., Action Phrase Handler, Prepositional Phrase Handler)
   2.c.1.1. Examine Phrases and IOs in previous successful queries
   2.c.1.2. Call Morphological database for handling morphology (e.g., tense, plurals)
   2.c.2. Parse Sentence Chunks (unresolved phrase tokens) against candidate Phrase Grammar
   2.c.2.1. Phrase Grammar parsing successful?
   2.c.2.1.1. (Yes): Mark unresolved phrase tokens in chunk as ‘Resolved’
2.b.2. (Outer Loop again, after Inner parsing loop):
   2.b.2.1. all Phrase Tokens resolved?
      2.b.2.1. (Yes): Parse Resolved Phrase Tokens against various Sentence Grammars selected from Sentence Parse Tree, until Sentence successfully parsed
      2.b.2.1.1. Sentence parse successful?
      2.b.2.1.1.1. (Yes): successfully parsed, exit outer loop.
   2.b.2.2. (not all Phrase Tokens resolved):
      2.b.2.2.1. Call B. Heuristics function (see below for breakout Acts).
      2.b.2.2.1.1. Phrase tokens modified?
      2.b.2.2.1.1.1. (Yes): Call inner parsing loop again with modified Phrase Tokens.
      2.b.2.2.2. Build fresh list of Unresolved Phrase Tokens as ‘Chunks’
      2.b.2.2.3. Calls inner parsing loop again.

3. Post-NLU Acts, if sentence successfully parsed.
3.a. Construct FrameSlot objects from Resolved Phrase Tokens
3.b. Send FrameSlot objects out to other cooperative Vobots modules as encrypted XML Packets
   2. Semantra™ Natural Language Understanding Engine
   A. Overview.

Semantra™ is one of several cooperative software modules, called Vobots Natural Language Processing (“Vocal NLP”). Vobots NLP software modules work in concert to allow a user to type or speak a natural language information request, and to then automatically retrieve the desired information from one or more data sources, and finally to return the answer set to the user.

Semantra™'s Roles as a ‘Cooperative Vobots Software Module’.

Semantra™'s principal role in the set of cooperative Vobots NLP software modules described above is to perform the ‘Natural Language Understanding’ (NLU) function. In this role, Semantra™ deciphers the meaning of a user's natural language request for information. Then it transforms the request into a set of ‘FrameSlot objects’. These objects are passed to another Vobots product (the SQL Generator), which generates and executes a database query to retrieve the desired answer from one or more ‘targeted’ data sources. Semantra™ performs several secondary roles and functions as well, among which are:
a. capturing and maintaining Semantic Phrases and Information Objects (entered by analysts or captured automatically from new user phrases),
b. initiating and controlling a ‘clarification dialog’ with a user to prompt him or her to clarify the request when such mediation is warranted,
c. synchronizing its two meta-repositories,
d. providing a GUI application whereby analysts and subject area experts can add, edit and delete Subject Area Information Objects,
e. providing an application whereby data administrators can add, edit and delete ‘Model Views’ and User Groups as a means of restricting parts of databases and subject areas to various classes of Users.

Semantra™'s NLU is used for other Vobots products and services (described in a separate document, not attached hereto). These additional Vobots products and services utilize Semantra™'s NLU to provide other functionality besides information retrieval, such as allowing users to issue natural language commands for a software agent (a ‘Vobot’) to complete some transaction or to perform some function, usually over a wireless connection.

Semantra™'s Mapping to Actual Data Sources to Which it (and the User) has Access.

Semantra™'s ability to perform its primary role described above—deciphering the meaning of a user's request to retrieve information, is limited to the availability of data sources a) that have been ‘vocalized’ (i.e., modeled) as a set of subject areas in Semantra™'s meta-repository (described below), and b) to which Semantra™ (and the user) have permission of access.

Semantra™'s Constituent Functional Modules.

Semantra™ comprises three functional modules:
a. Natural Language Understanding (NLU) module.
b. User Clarification Dialog module.
c. Semantic Phrase lexicon maintenance module (manual and automatic phrase capture).

These functional modules are described in the ‘Claims’ sections below following this overview.

Semantra™'s Meta-Repositories.

Semantra™ comprises of several ‘meta-repositories’ which supply vital metadata for its processes.

a. Semantra™'s Model Metadata Meta-Repository.

The Model Metadata meta-repository contains subject areas, each with a set of Information Objects (‘IOs’) (Information Objects are the ‘names of things’ in a subject area, as a user might refer to them, as opposed to the more technical terms a database expert might use. Information Objects may be names of ‘Entities’ (‘Entity IOs’) or names of ‘Entity Attributes’ (‘Attribute IOs’))—commonly referenced objects within the subject area. These subject areas (‘ontologies’) are hierarchical: Each subject area has a ‘parent subject area’, except for ‘top’ subject areas. IOs are related to each other through semantic relation rules and lexical relation rules (Semantra™ employs two types of semantic relation rules: hypernymy/hyponymy (‘is-a’ or ‘generalization /specialization’ hierarchy) and meronymy/holonymy (‘has-a’ or ‘whole-part’ hierarchy). In addition, Semantra™ utilizes lexical relation rules (synonymy, antonymy)), which are set by database experts and/or subject area experts. Other IO association rules are implied from the relationships between Entity IOs (i.e., cardinality rules) within each ontology.

Within each subject area ontology, all access to database tables and columns is restricted to ‘Model Views’. Within each Model View, Information Objects (IOs) are maintained which map to actual database’ tables and columns. These Model Views and IOs are the means by which a Data Administrator can restrict classes of users in accessing target databases. Semantra™ includes a GUI-based Data Administration utility program (described in a separate document, not attached hereto) which allows a subject area expert or data administrator to add, delete or modify Model Views and IOs. An Entity IO is first created automatically as an object with a one-to-one relationship (view with no joins and no restrictions) with a ‘base table’. However, IOs can be added or modified such that an Entity IO can include Attribute IOs which ‘belong’ to other base table Entity IOs.

b. Semantra™'s Semantics Meta-Repository.

The Semantics meta-repository contains a ‘mirror image’ of Information Objects (IOs) maintained in the Model Metadata meta-repository. In addition, the Semantics meta-repository contains semantic phrases and dimension IO values (described more fully below), ontological phrases, and general phrases. Semantic phrases include subjective phrases, which link to IOs (see section above regarding Model Metadata), generic phrases (‘speech acts’) and base phrases ‘the base’ lexical phrase type for each phrase handler).

Ontological Phrases are nouns, verbs, adjectives and adverbs which pertain to a particular subject area (ontology), but not to any specific IO in the subject area (e.g., ‘in the record book). General phrases are general in nature and are not limited to any specific subject area (e.g., ‘in the World’).

c. Semantra™'s Grammatics Meta-Repository.

The Grammatics meta-repository contains grammatical terms: ‘parts of speech’ terms such as generic adjectives (e.g., ‘best’, ‘superior’), adverbs (e.g., ‘fastest’), prepositions, and conjunctions, for example). Also, the Grammatics Meta-repository is tied into a morphology data set within a public semantic database (WordNet). This data set provides morphological functions (e.g., singular/plural transformation, past tense/present tense transformation) for Semantra™'s NLU.

Semantra™'s NLU Functionality and Process.

Semantra™'s ‘Natural Language Understanding’ (NLU) module attempts to ‘understand’ the meaning of a user's natural language requests (usually requests for information). Semantra™'s NLU does not attempt to understand a user's request for information to the degree that a human can: its goal is to discern or recognize words and phrases in the request which can be ‘mapped’ to entities and attributes in subject areas stored in its meta-repository. As an extension to its present implementation, Vobots, Inc. has designed a methodology which will extend the Semantra™ NLU's logical capabilities into the realm of ‘conceptual reasoning’. Both in its present and next-version designs, Semantra™ employs deductive, inductive and first-order logic processes to achieve its NLU function.

A simple overview of the Semantra™ NLU's process is:
a. Input: Semantra™ receives a simple text message—a sentence or phrase stated in the user's natural language (note: the user either types in this text message or speaks the message, in which case the message is converted to text through a third party Speech-to-Text Converter software module).
b. NLU parsing and transformation: Semantra™ parses the text message to ‘understand’ the meaning of the message, and transforms it to a sufficient degree that the request can subsequently be converted to a database query (by other Vobots software modules).
c. Output: The Semantra™ NLU packages the parsed message into a set of ‘FrameSlot’ objects, each containing a Subject Area IO and any associated rules or condition expressions. FrameSlot objects are encrypted as XML packets and sent off to other cooperative Vobots software modules, which are logically (and frequently physically) decoupled from the NLU itself.

These other Vobots modules 1) extract the FrameSlot objects and map the Subject Area IOs to actual database tables and columns, 2) construct and execute database queries against the targeted database(s), and 3) return the desired information requested back to the user. These other Vobots modules are described and filed as patent claims separately in other documents.

2.1 Semantra™'s Parser: Integrating Semantic Phrase Parsing, Ontology/Conceptual Parsing. Transformational Parsing with Metarules, Syntactic Parsing and Examination of Previous Successful Queries.

A parser, which is part of its Semantra™ Natural Language Understanding (NLU) module, uniquely combines and integrates different parsing techniques. In addition, its parsing function includes an examination of previously successful queries to help choose between ‘candidate IOs’. The unique integration of different parsing techniques allows its parser to achieve a higher degree of accuracy than other Natural Language products.

2.2. Semantra™'s Special Phrase Handlers.

Semantra™'s NLU parses sentence segments (phrases) with separate modules, called Phrase Handlers. When a specific phrase handler identifies the phrase being parsed as the particular type of phrase which it can process (‘handle’), a phrase handler module transforms a set of tokens, called Phrase Tokens, with special ‘features’ and attributes, and then sends its parsed set of phrase tokens to Semantra™'s parser, along with Phrase Grammars for that type of phrase.

Semantra™'s phrase handlers specifically handle phrase types such as prepositional phrases, action phrases (subject/verb/predicate object), speech acts, ontological phrases and general phrases, for example. Two of Semantra™'s phrase handlers, the action phrase handler and the dimension IO value handler, are both extremely powerful techniques for parsing.

2.3. Semantra™'s Hierarchical Ontologies and Information Objects.

Semantra™ contains meta-repositories which contain sets of subject areas, or ontologies. The ‘ontological objects’ to which users refer are called Information Objects (IOs). IOs are described in section above regarding Semantra™'s Model Metadata meta-repository.

2.4. Semantra™'s Automatic and Dialog-Driven Capturing of Semantics and Information Objects.

Originally, semantic phrases, synonyms and Subject Area Information Objects are entered into the Semantics lexicon by Subject Area Experts. Subsequently, during its actual user request processing, Semantra™ can add new forms of user phrases, synonyms and IOs to its meta-repositories. The functionality and capabilities covered in this claim are separate to, but work in conjunction with, the Semantra™ NLU itself.

2.5. Semantra™'s Reasoning Methodology.

Semantra™'s NLU normally utilizes ‘shallow parsing’ (matching semantic phrases to Ontological objects without truly ‘understanding’ the conceptual meaning of either the phrase or the ontological objects). However, mechanisms for providing a ‘deep parsing’ capability are foreseeable, particularly where phrases are mapped to a deeper ‘conceptual level’ of ontological objects. This new mechanism will allow the Semantra™ NLU to correctly disambiguate many more types of user information requests. In addition to its use by the Semantra™ NLU for handling information requests, this deep parsing methodology allows Semantra™ to ‘reason’ about concepts through first order logic. With the ability to draw logical conclusions and conduct reasoning about a user's natural language statements, NLU will be extended beyond information retrieval. Market spaces for these Vobots, Inc. products include Business Intelligence (B.I.) and wireless ‘personal agents’.

2.1. Semantra™'s Integrated Parser

Overview

As a point of background information, Natural Language Understanding (NLU) is a vital part of Natural Language Processing, the term most people in the Computer Science and Computational Linguistics fields use for applications which process or transform human natural language. An NLU contains the parsing function, and as its name suggests, an NLU attempts to ‘understand’ a natural language document, text or speech act. Many researchers in the scientific field of Natural Language and Computational Linguistics are investigating variations of Generalized Phrase Structure Grammar and ‘unification models’, which essentially are Context Free Grammars (those grammars which do not rely on pragmatics or context to decipher meaning). Other researchers emphasize ‘Ontology’ (the meaning of concepts) as the basis for NLU parsing.

Semantra™'s parser integrates different types of parsing: a) Semantic Phrase parsing, b) Ontological/Conceptual parsing, c) Syntactic (grammatical) parsing, and d) Transformational Parsing with metarules. In addition, Semantra™'s parsing logic includes a ‘reasoning module’ and a mediation process for deciding between ‘candidate’ plausible meanings: an examination of previous successful queries to find the statistically most successful interpretation.

One Semantra™'s Parsing Strategy: Mapping Phases to Ontological Objects.

In Semantra™, phrasal semantics and lexical concepts are tied together: words and phrases are analyzed both by syntax and semantics. Ultimately the nouns and adjectives in a user's sentences which are not part of a grammatical lexicon (i.e., semantic phrases) must be identified with concepts in a context of a known ontology, or must be deduced with relative assurance to being found as values of a conceptual attribute type (i.e., domain) in a database or other data source. The interpretation of semantic phrases as they relate to concepts is called ‘pragmatics’ (The term pragmatics is usually attributed to the British philosopher Charles Morris (1938-71), who distinguished between syntax (the relations of signs to one another), semantics (the relations of signs to objects), and pragmatics (the relations of signs to interpretations)).

In the Semantra™ architecture, the ‘concepts in a context of known ontologies’ are its hierarchical subject areas, and its conceptual objects are its Information Objects (“IOs”). Semantra™'s NLE is heavily committed to Ontology/Conceptual parsing, the scientific basis of which is Roger Schank's Conceptual Dependency theory. Information Objects are the entities and attributes of specific subject area, or ontologies, supplied to Semantra™ as entity-relationship models. Each ontology's metadata is captured in Semantra™'s Model Metadata meta-repository through ‘vocalization process’. IOs are also stored in the Semantics meta-repository. The IOs in the Semantics meta-repository are always synchronized with their counterparts in the Model Metadata meta-repository. The rationale of Semantra™'s emphasis on mapping phrases to IOs is based on the product design goal of the overall Vobots NLP itself, which is limited to retrieving answers to natural language information requests and to carrying out direct transactional commands. This purposeful limitation of Vobots NLP differentiates it from other types of NLPs which attempt more ‘ambitious’ tasks (e.g., automatically scanning and interpreting the meaning of documents).

Semantra™'s Parsing Methods and Process.

The various mechanisms and strategies of Semantra™'s parsing process are explained below. The most important determinant for the capabilities of Semantra™'s parsing logic is the unique combination and integration of these various parsing mechanisms.

a) Semantic Phrase Parsing.

Semantra™'s parser is a generative parser (A term borrowed in the 1960s from mathematics into linguistics by Noam Chomsky. If a grammar is generative, it accounts for or specifies the membership of the set of grammatical sentences in the language concerned by defining the precise rules for membership of the set), similar to XML's DTD parser. In Semantra™, ‘semantic phrases’ are recorded in the Semantics Lexicon, linked hierarchically. These phrases represent language grammar phrase types (e.g., Noun Phrase, Verb Phrase, Prepositional Phrase), plus some special Phrase Types useful for parsing questions and sentences submitted by users who simply want facts or answers from databases (e.g., ‘Generic Phrase’, ‘Dimension IO Values Phrase’).

The first preliminary pass of Semantra™'s NLU reduces the sentence into phrase tokens, using certain grammar rules for determining the parts of speech (POS) of the sentence. Semantra™ comprisess of a set of Phrase Handler modules which analyze sets of phrase tokens in a sentence to determine a possible phrase type (Generic Phrase, Action Phrase, Prepositional Phrase, and Conjunction, for example). For example, a Prepositional Phrase handler looks for a leading preposition (say ‘in’) and then looks for a trailing Noun Phrase which it can match against its known Candidate Subject Area IOs or against its Candidate Dimension IO Values. During Semantra™'s phrase parsing, phrase tokens are analyzed as ‘chunks’ (sentence fragments). If the sentence chunk passes the analysis of one of Semantra™'s phrase handlers, the phrase tokens that constitute this ‘Candidate Phrase’ are passed to Semantra™'s parser, along a set of one or more grammars which linguists have constructed for that type of phrase. If the NL parser matches the phrase tokens against one of its valid grammars, the set of phrase tokens is validated (and all member phrase tokens of the phrase are reclassified as the phrase type of the grammar's phrase type). Finally, phrase tokens are all reduced to Semantra™'s ‘base phrases’, which are subjected to the NL parser to validate the entire sentence.

b) Ontology/Conceptual Parsing.

Users request information about a given subject area, or ontology. When a user first requests information about a subject area, Semantra™ brings into the object space (instance) of the parser a hierarchical set of subject areas and their IOs (stored as an object type ‘Subject Area IO’), starting with the given subject area and recursively bringing in each subsequent parent subject area and its IOs. The resultant list of this pre-process is a subset of ‘candidate Subject Area IOs’ for the actual parsing loop to follow. Because the candidate Subject Area IOs are restricted to only those subject area hierarchies pertinent to the selected topic (i.e., highest Subject Area), these object instances are kept in computer RAM memory for fast parsing and processing. After the first preliminary pass of Semantra™'s NLU, a second preliminary pass is made, in which a method is invoked which iterates through the list of sentence phrase tokens, trying to match each phrase token to one or more Subject Area IOs. All of a phrase token's matching Subject Area IOs are collected and stored as a list (vector) in the phrase token object.

In Semantra™, ontologies are mapped hierarchically, but the ‘conceptual objects’ within each ontology (Subject Area IOs) are mapped more freely: they may track hierarchically to parent Subject Area IOs in ontologies other than the lineage of their ‘home’ ontology. Subject Area IOs are either Entity IOs or Attribute IOs. Entity IOs map ‘objects’, while Attribute IOs map ‘object properties’ (entity attributes). Conceptually, Attribute IOs are more closely aligned with ‘domains’ (i.e., data types of attributes), which may map to properties of abstract concepts in Semantra™'s Semantics meta-repository, such as ‘Spatial Objects’, ‘Temporal Objects’, and ‘Events’. Conceptual objects (domains of Subject Area IOs) are also associated with sets of semantic phrases. For example, the words ‘when’, ‘after’, ‘before’, ‘at the same time’ and ‘simultaneous’ are all semantic words and phrases having to do with the concept of time. When a concept-triggering semantic phrase is encountered in a sentence, certain concept-oriented logic methods are invoked to find temporal (i.e., time-oriented) IOs, such as date attribute IOs, or ‘event-oriented IOs’ (i.e., an Entity IO having a date-time Attribute IO as one of its identifiers).

c) Syntactic Parsing.

Semantra™'s NLU emphasizes lexical and ontological mapping of sentence phrases to Subject Area IOs. But Semantra™'s NLU also utilizes a syntactic parser to evaluate a Phrase Structure Tree (S-Tree) to help link phrases correctly in complex sentence structures. Several ‘morphosyntactic taggers’ for constructing an S-Tree are possible. In Semantra™, the NLU performs a ‘pre-parsing function’ of constructing a Phrase Structure Tree (S-Tree), where each word or phrase is assigned a syntactic category—e.g., Sentence (S), Noun Phrase (NP), and Verb Phrase (VP), for example. Semantra™'s Grammatics meta-repository contains the annotation rules associated with its S-Tree generation parser, so that the tagged phrases (e.g., Noun Phrases, Verb Phrases, Prepositional Phrases) are ‘linked’ together with the most probable interpretation of a user's natural language request. Syntactic parsers parse syntactic and lexical (i.e., structural) elements, most usually of a class known as Phrase Structure Grammars. Semantra™'s syntactic parser, on the other hand, employs its own set of Phrase Structure Tree parsing rules. Semantra™'s syntactic parsing routines parse the S-Tree to break a sentence into ‘grammatical chunks’. At the first level, chunks are clauses, which are then broken further into lower-level phrase chunks. Semantra™'s Grammatics meta-repository contains both Sentence grammars and Phrase grammars. These grammars have a many-to-many relationship: each Sentence grammar in Semantra™'s Grammatics meta-repository has associated with it a selected set of Phrase grammars for each Phrase type, and the same Phrase grammar may be utilized in many different Sentence grammars.

d) Transformational Parsing with Metarules.

Semantra™ utilizes a ‘reasoning module’ which attempts to deduce a ‘deep conceptual understanding’ of the meaning of a user's phrase, where possible and practical. This module employs ‘metarules’ to the concepts it has discovered through its syntactic parsing (The method of using metarules against a phrase structure grammar was published in an internal SRI document: “Capturing Linguistic Generalizations with Metarules in an Annotated Phrase-Structure Grammar”, Karl Konolige, SRI International).

Semantra™'s Parsing Loop.

Semantra™'s ‘outer parsing loop’ constructs ‘candidate Sentences’ by consulting the S-Tree. Each Sentence grammar selected carries with it a set of Phrase grammars, which are used in Semantra™'s ‘inner parsing loop’ for phrase matching and phrase parsing. Semantra™'s ‘inner parsing loop’ tries to resolve those phrase tokens in the sentence which are still unresolved from previous iterations. The technique employed is to examine the unresolved phrase tokens together as a ‘chunk’. This chunk is examined in turn by each phrase handler module, until all or part of the chunk is resolved as a particular phrase type and passes its phrase type grammar parsing. Two particular types of phrase handlers employed within this inner parsing loop are Semantra™'s Action Phrase Handler and its Dimension IO Value Handler. Both of these phrase handlers are described in a separate claim filed by Vobots, Inc. (“Claim 2.2. Semantra™'s Special Phrase Handlers.doc”).

2.2 Hierarchical Ontologies and Information Objects

Overview

Semantra™ is a Language Understanding Engine (“Semantra™”). Within Semantra™ is a specialized Natural Language Understanding (NLU) module which contains a ‘Phrase Parser’ and a set of ‘Phrase Handlers’. Semantra™contains meta-repositories which contain sets of subject areas, or ontologies. The ‘ontological objects’ to which users refer are called Information Objects. Subject areas are hierarchical: each subject area ‘is-a’ specialization of another (parent) subject area (except for ‘top’ subject areas, which have no parents). Information Objects (IOs) are also hierarchical, but are not limited to hypernymy/hyponymy (‘is-a’) hierarchies. IOs can be parented through holonymy/meronymy (‘has-a’) hierarchies as well.

Explanation of the Structure and Maintenance of Information Objects in Meta-Repositories

Semantra™ contains ‘meta-repositories’. These meta-repositories contain metadata for all of the subject areas (ontologies) which have been modeled and added to the Semantra™ lexicon. Semantra™ does not maintain any ‘targeted databases’ directly: the metadata for these actual databases exists on servers at the corporate sites of Vobots, Inc.'s client customers. One may model a new subject area and add it to Semantra™'s meta-repositories. This modeling process is one part of the ‘vocalization process’ (the other part of the process being the addition of semantic phrases pertaining exclusively to the new subject area). Users can ‘vocalize’ their databases so that the their users (typically employees and/or customers) can access these databases through natural language. The process for doing this is called ‘vocalization.’ If the actual database is relational, its metadata is added to Semantra™'s lexicon as its own subject area (which is in turn linked hierarchically to an existing subject area in an existing lexicon). If the company data source is not relational, a ‘data mapping’ process builds data transformation logic which maps the non-relational data source to an existing subject area.

A new subject area ontology ‘is-a’ specialization of a previously defined ontology. Within each new ontology (even if it describes an actual database), the table and columns of the ontology database are given ‘natural language’ names. These entities and attributes are called Information Objects. The new subject area's ontology Information Objects are likewise hierarchically typed, but each IO within a given ontology can have as its parent an IO which may be a constituent of a different ontology from its own parent. When an actual target database is vocalized, and if the target database is relational, its data structures are treated as just another subject area and is typed to its immediate parent subject area in the same manner. In the vocalization process, the closest ‘parent information object’ is selected for all database elements—tables keyed to a parent ‘Entity IO’, columns keyed to a parent ‘Attribute IO’, and columns. Semantra™'s Information Objects are original in the manner in which they are utilized to supply semantic meaning to Semantra™'s NLU:

a) Mapping a User's Nouns to Subject Area IOs.

Most sentences in a user's request for factual information contain action phrases (discussed above). For the sentence to be parsed successfully (i.e., for an actual answer to the user's request for information to ultimately be found), the subject and predicate nouns in these action phrases will reference one or more subject area IOs known to Semantra™. One advantage in one embodiment is that Semantra™ maps sentence phrases to Information Objects (Entity IOs and Attribute IOs), not to database elements (table names and column names). So a user's request for information (which by definition refers to ‘information objects’ in a given subject area) is interpreted and transformed by the Semantra™ NLU, usually with no further user interaction, to a form from which a database query can retrieve the answer.

b) Resolving Semantic References Indirectly, Through Subject Area Hierarchies.

Two users may ask for the same exact information, but use words which differ in their ‘specificity’ level. Semantra™ maps IOs to a common ‘base concept’, thus matching ‘ontological object relationships’ not otherwise discovered by searching within only one ontology at a time. To illustrate, say the subject area ‘Business’ contains a Semantic Phrase ‘Employee works in Work Group’. Say that two separate user requests are sent to a company's vocalized Manufacturing database: 1) “how many employees work in Field Sales?”, and 2) “how many engineers work in each department?” Manufacturing ‘is-a’ Business, Engineer ‘is-a’ Employee, and ‘Field Sales’ is a Dimension IO value for a Department, which ‘is-a’ Work Group. Using logic (implication and inferencing), Semantra™'s NLU determines that both of these two user requests refer to the same types of objects—Engineer and Department, even though there were no exact Semantic Phrases for Manufacturing to precisely match either request's Information Objects. The parent document mentioned above, describes the algorithms and process by which the Semantra™ NLU derives meaning by utilizing its Hierarchical Subject Area Information Objects.

Thus, the vocalization process readies a corporate database for retrieving information based on natural language information requests. Due to the hierarchical nature of its subject area ontologies, a new corporate database can start retrieving natural language queries almost ‘out of the box’, with perhaps as much as 80% to 90% of the semantic questions relating to the database already known.

2.3. Automatic and Dialog-Driven Capturing of Semantics and Information Objects

Overview

Within Semantra™ is a specialized Natural Language Understanding (NLU) module which relies in part on metadata supplied in Semantra™'s meta-repositories. The Semantics meta-repository contains Semantic objects: Semantic phrases, synonyms and subject area ‘background terms’. The Model Metadata meta-repository contains Subject Areas and Information Objects (IOs). During the Semantra™ NLU process, a user's natural language request for information is broken into sentences. Each sentence is ‘tokenized’ into a set of Phrase Tokens. Semantra™'s parsing process attempts to match phrase tokens to Semantic Objects in the Semantics meta-repository. Originally, semantic objects are entered into the Semantics lexicon by Subject Area Experts (SMEs). Subsequently, during its actual user request processing, Semantra™ can capture and add new forms of user phrases (called ‘Semantic Phrases’) to refer to IOs in its Semantics meta-repository.

Semantra™ contains techniques and modules which add Semantic objects both ‘automatically’ and through ‘User Dialogs’ with users and with subject area experts (SMEs). Semantra™ can also allow an SME to add Information Objects through natural language ‘commands’, prompted from the SME through a User Dialog. This ability to dynamically add Semantic objects and IOs during the NLU process allows the Semantra™ lexicon to ‘grow’ heuristically—a valuable asset for a Natural Language product such as Semantra™. During the NLU parsing process, a NLU routine (the Action Phrase Handler) searches for a ‘triple’ (i.e., set of phrase tokens containing a Subject Noun Phrase, Verb Phrase and Predicate Noun Phrase). When this Phrase Handler finds two of the three phrase tokens, it invokes one of two methods for automatic capturing of Semantic Phrases. These strategies are described below.

Explanation of Automatic Semantics Capturing without User Prompting.

When Semantra™'s NLU is scanning a sentence, it searches for a triadic predicate, or ‘triple’ (Subject-Verb-Predicate Object). If the search results are 1) no Subjective Phrase matching both the Subject Noun Phrase and the Predicate Noun Phrase, but 2) both Noun Phrases matching Subject Area IOs in the Semantics Subject Area IO table, then the NLU marks this sentence phrase as the first Semantic Phrase linking these two Subject Area IOs (with its Action Verb Phrase marked as the ‘default action verb’ for these two Subject Area IOs). So the Semantic Phrase is automatically added to the Semantics meta-repository, without any prompting or intervention from the user.

Explanation of Automatic Semantics and IO Capturing with User Prompting

If Semantra™'s search for a triple results in 1) matching both the Subject Noun Phrase and the Predicate Noun Phrase to Subject Area IOs, and 2) finding no Action Phrase which matches its Action Verb Phrase with these two Noun Phrases in the Semantic Phrase table, and 3) finding one or more Action Phrases in the Semantic Phrase table with these two noun phrases, then Semantra™ invokes an instance of the User Clarification Dialog class. This dialog prompts the user to indicate whether or not the verb phrase in the sentence is a synonym of the action verb phrases in the list of Action Phrases linking these two noun phrases. If the user indicates that the Action Verb Phrase is a synonym (by selecting the synonymous Action Verb Phrase from a list of Candidate Action Verb Phrases), the new Synonym is added to that Semantic Phrase's Synonym list.

If the user indicates no match as a synonym, then the user is prompted to supply a ‘Conditional Phrase’ which differentiates the new Semantic Phrase from the other existing Action Phrase(s) linking the two Subject Area IOs. This Condition expression must be in the form ‘<Attribute IO><relational operator><Value|Attribute IO>. A dialog is entered into which guides the User in supplying a Subject Area IO Condition which will be used in the future for distinguish this new Semantic Phrase. To supply the Subject Area IO Condition expression, the User selects one or more Subject Area Attribute IOs, each having an associated Conditional Operator and a Value (or alternatively a second Subject Area Attribute IO).

When a new conditional phrase has been defined to specialize a Subject Area IO, a regular user in effect ‘adds’ a new Semantic Phrase, automatically. If the user is an SME, he or she is prompted as to whether to record this new definition as a new Information Object or whether record the new condition as part of a new Semantic Phrase only.

### EXAMPLE #1

As an example, using a Baseball subject area, say a new user phrase is encountered: ‘Which New York Yankees catcher had the most home runs in a season?”. Say that there is an existing IO, ‘Player’, but there is no IO named ‘Catcher’. Say also that the user is a qualified SME (recorded as such in Semantra™'s meta-repository). Through prompting the user to define ‘Catcher’, the user states that ‘a Catcher is a Player whose Preferred Position is ‘Catcher’ (mapping to the condition: Position.Position Name=“Catcher”). Since the user is an SME, he or she is prompted as to whether to record the new phrase and condition as only a new Semantic Phrase, or to add, a new IO named ‘Catcher’ to the Model Metadata meta-repository. If the SME authorizes the latter action, there will now be an IO in the Baseball subject area named Catcher.

### EXAMPLE #2

As a second example, again using a Baseball subject area, say there is an existing Semantic Phrase “Team plays in Playoff Event” (where the two noun phrases are ‘Team’ and ‘Playoff Event’ and the action verb phrase is ‘plays in’). Say a new user request is “Which team won the World Series in 1996?” In parsing this sentence, the Semantra™ NUL first finds the phrase ‘World Series’ as a Dimension IO Value. This Dimension IO Value is for the subject area IO ‘Playoff Event.Event Type’. Since this new Semantic Phrase contains a new Action Verb Phrase for the two Subject Area IOs ‘Team’ and ‘Playoff Event’, the user is prompted as to whether ‘wins/won’ is a synonym for ‘plays in/played in’. If the user indicates that it is not, the User Dialog is engaged in which the user is asked to ‘clarify’ the sentence phrase. The user is prompted to enter a Condition expression which will ‘specialize’ (differentiate) the Semantic Phrase. The user might specify this Conditional expression: “Playoff Event.Games Won greater than Playoff Event.Games Lost”.

So the entire Semantic Phrase, together with its Phrase Condition, would be “Team wins Playoff Event”, where ‘wins/won’ equates to “where Playoff Event.Games Won>Playoff Event.Games Lost”. Note that this new Semantic Phrase and its associated Phrase Condition apply to any type of Playoff Event in Baseball, not just to the World Series. In this example, the user, whether or not he or she is an SME, is not asked whether to ‘permanently’ add a new IO, because the only part of the phrase that was ‘unknown’ was the Action Verb Phrase, not the Subject IO or Predicate IO.

Summary.

The invention has an original capability of heuristically adding to its lexicon, both in its Model Metadata meta-repository as a new Information Object and in its Semantics meta-repository as a new Semantic Phrase. Since new phrases and/or IOs are derived from existing objects, their parent object is known automatically.

2.4. Reasoning Methodology

Overview.

Within Semantra™ is a specialized Natural Language Understanding (NLU) module which relies in part on metadata supplied in Semantra™'s meta-repositiories. The Semantics meta-repository contains Semantic objects: Semantic phrases, synonyms and subject area ‘background terms’. The Model Metadata meta-repository contains Model Views and Information Objects (IOs). Semantra™'s NLU normally utilizes ‘shallow parsing’ (matching semantic phrases to Ontological objects without truly ‘understanding’ the conceptual meaning of either the phrase or the ontological objects). However, Vobots, Inc. is developing mechanisms for providing a ‘deep parsing’ capability, wherein phrases are mapped to a deeper ‘conceptual level’ of ontological objects. The invention architects a new methodology for allowing Semantra™'s NLU to employ ‘deep, conceptual understanding’, in those cases where a user's natural language request is unusually complex.

Need for Conceptual Reasoning.

Natural Language Understanding (NLU) systems attempt, by various means, to disambiguate the meaning of a natural language sentence or source document. This is extremely difficult for a machine to do; after all, sometimes even humans have difficulty understanding a writer or speaker's meaning, purpose and/or motivation. In the Semantra™ NLU, several types of parsing methods are used: syntactic, semantic and pragmatic (ontological, conceptual). The Semantra™ NLU's strategies to deduce the meaning of the words used in a user's request for information may be called a ‘shallow understanding methodology’: there is a ‘shallow’ chain of logic: sentences contain phrases which map to ontological Subject Area IOs, which ultimately map to actual database tables and columns, thus allowing an SQL query to be dynamically generated to extract data from targeted databases and returned to a user as answer sets.

Semantra™'s NLU, as stated above, focuses primarily on information retrieval. In effect, Semantra™'s NLU only performs ‘lookups’ and pattern matching to perform its tasks. Nearly all of the logic, or reasoning, in the chain of events for retrieving answers in Vobots, Inc.'s technology are performed by SQL (performed by another Vobots module, which generates and executes the SQL query against targeted databases. It has been shown that SQL is in fact a ‘first order predicate logic’ (FOPL) methodology, exercising most of the inferencing and deductive (forward chaining) logic that can be accomplished in set theory, Boolean algebra and other computational logic approaches. There is no NL methodology that has successfully demonstrated an ability to accurately understand human conversation, even to the level of ability of a young child. Notwithstanding the difficulty in ‘automatically reasoning about concepts’ to deduce a writer or speaker's meaning, Vobots, Inc. has added constructs to achieve a limited ability to make reasonable deductions and inferences in its parsing tasks.

Explanation of Reasoning Methodology.

The invention incorporates a set of conceptual objects, associated with its IOs and its subject areas, from which limited reasoning and deductions can be made by the Semantra™ NLU. These conceptual objects contain ‘goals’, ‘rules’, and ‘ontological commitments’ which help to interpret a user's meaning in information requests. One strategy for making rational deductions and inferences is to utilize its ontological and/or semantic constraints (i.e., conditional expressions) in a ‘rules engine’. This engine can ‘backward chain’ ontological goals and rules to fire conditional expressions. The result of this rules engine is that the Semantra™ NLU can make inferences and deductions about semantically ambiguous phrases. Semantra™'s ontological constraints, together with its conceptual domains (subject area IOs), allow for certain variations of IOs (subtypes). Also, constraints are the basis for inferences: a system could make better guesses of the exact meaning of a sentence if it could draw inferences upon its knowledge base, rather than having only the ability to map phrases to conceptual objects.

Also associated with this methodology are algorithms within the Semantra™ NLU for ‘Transformational parsing with metarules’. These algorithms utilize the rules engine mentioned above, only in a different context (more to do with phrasal and lexical interpretation to derive deep conceptual meaning from phrases). To illustrate the power of using constraints, an example question about the subject area ‘Major League Baseball’ is used: “How far did the Yankees make it in 1992?” A system based on ontological constraints in addition to just facts could look up the action verb ‘make it/made it’ to find that it is a synonym for ‘progress’ in a phrase such as ‘((Team)) progresses through ((Season))’. Then in Semantra™, with its ability to map semantic phrase through its type hierarchy, it would draw inferences in the following manner: In the general ‘Sports’ subject area, ‘Competitive Sports’ include ‘Competitive Events’, with two basic types of ‘Competitors’: ‘Teams’ (for ‘Team Sports’) and ‘Athletes’ (for ‘Individual Competitions’). A basic tenet of Competitive Sports is a series of Competitive Events (a “season”), the goal of which competition is to determine the ‘Overall Winner’. The Sports ontology contains a set of rules, such as “Team Sports have a ‘Regular Season’ followed by a ‘Playoff Season’”. This Sports ontology contains separate Entity IOs containing statistical data for the Regular Season (“Regular Season Batting Stats”, ” Regular Season Pitching Stats”) and for the Playoff Season (“Post-Season Batting Stats”, “Post-Season Pitching Stats”). Through constraints and ontological concepts, Semantra™ would ‘know’ that a team attempts to reach a goal (Overall Winner), by progressing through a Season and then through a Playoff Season. So Semantra™ would use inferences to determine how far a Team (the Yankees) ‘made it’ in (the season of) 1992.

Another reason for adding ‘deep conceptual knowledge’ and constraints is that a user will be ‘put off’ if a request is not ‘understood’ in a common-sense manner. If a user asks a question, but Semantra™ misinterprets the request and tries to fetch a ridiculous and nonsensical question, the Semantra™ NLE may be immediately ‘exposed’ in the user's eyes and ears as being an untrustworthy source of information. To illustrate this point, a Baseball Statistics subject area contains facts about baseball players, teams, player stats (e.g., “who hit the most home runs in the National League in 1986?”). A non-serious user, just to ‘check to see how smart this system is’, may ask an absurd question (“how many players in the National League were over 28 feet tall?”). Semantra™'s ontological rules includes certain ‘common-sense’ limits or ‘value boundaries’ for ‘fact type entities’. So stored in the metadata of the Player entity attribute ‘Player.height’ are upper and lower ‘common-sense’ limits: a player may not be shorter than say, 4′ 10″ or taller than say, 7′ 8″ (although the famous ‘Bill Veeck midget episode’ might have failed this common sense test). Semantra™ includes a dialog through which subject area experts to specify constraints (conditional expressions’) to be able to distinguish between ‘types’ without resorting to actual values. For example, say a particular subject area of a target database has abstracted ‘books’ into a generic parent (say, ‘Titles’), so that other types of published works could be stored as well as books (CDs, movies, works of art).

In this subject area ontology, ‘Book’ is no longer a metadata ‘concept’: it's a value in a characteristic table (‘Title Type’), along with other types such as ‘Movie’. In Semantra™, the analyst or subject area expert would ‘subtype’ the generic Title entity, by exposing the characteristic types (‘Book’, and ‘Movie’, for example) as Information Objects themselves. To subtype a new IO ‘Book’ from its generic parent, the new IO ‘Book’ is defined as ‘Title’ with a conditional expression “Title.type=‘Book’”. Actually, Semantra™ works just as well by leaving the ‘Book’ as a value, because it has recorded the values of characteristic type entities like ‘Title Type’.

Summary.

The methodology for reasoning outlined herein allows the invention to correctly disambiguate many more types of user information requests. Even more importantly, this deep parsing methodology will allow Semantra™ to ‘reason’ about concepts through first order logic. With the ability to draw logical conclusions and conduct reasoning about a user's natural language statements, the invention is able to greatly extend its NLU beyond just information retrieval.

3. Vobots Data Mapper/SQL Generator

Overview

One distinction of Vobots NLP over the prior art is the manner in which the processing of a single natural language user request for information is distributed (Vobots NLP is normally distributed in its architecture. There is a more ‘lightweight’ version of the product in which its cooperative software modules exist on one computer, thus eliminating the XML routing and management function—but otherwise conceptually shares the same decoupled architecture; functionality described in this document is with regard to the normal, distributed architecture) between individual, decoupled software modules and software agents:
Vobots Semantra™ (Natural Language Understanding Engine)
Vobots Request Manager/Router
Vobots Data Mapper/SQL Generator
Vobots Answer Set Formatter

First the user's request preferably arrives as text at the beginning of the process, either typed by the user or after a speech recognition product converts a voice message to text. Then the Semantra™ Natural Language Understanding Engine parses the text request and produces a set of ‘FrameSlot objects’. These objects are encrypted and sent to the Vobots Request Manager/Router. The Vobots Request Manager/Router receives an encrypted XML packet set and routes it across the internet or Virtual Private Network to one or more customer sites having target databases. At each site, a Vobots Data Mapper/SQL Generator software agent dynamically generates SQL queries and returns answer result sets from targeted databases to the user.

The Vobots Data Mapper/SQL Generator module performs four functions:

1. Listener/XML object transcription. The module ‘listens’ for incoming XML packets and decrypts and deserializes FrameSlot objects from the XML packets.

2. Data mapping. ‘Information objects’ contained in FrameSlot objects are mapped to actual database tables and columns in target databases located at the site at which the Vobots software agent is running.

3. SQL Generation and Execution. SQL queries are dynamically generated and executed against targeted databases.

4. Query result set serialization, encryption and dispatch. Result sets (answer sets) are serialized into XML packets, which are then encrypted and sent back to the Vobots Request Manager/Router module.

Functional Description

Below it is explained how functions are performed within the Vobots Data Mapper and SQL Generator software module as it plays its part in the distributed Vobots NLP process.

1. Listener/XML Object Transcription.

The Vobots Request Manager and Router module determines which target databases will be queried for the request query packets it has received. At each customer's site, a ‘live’ Vobots Data Mapper/SQL Generator software module waits to process incoming queries for targeted databases at that site. This module is a ‘Vobots software agent’: a listener thread is always running and is ‘listening’ for incoming data. When an incoming query arrives at the site, the Vobots Data Mapper/SQL Generator first receives a header message packet, telling the listener agent how many query packets are being sent. The software agent listener thread responds with an acknowledgement packet, and another thread is set up to start receiving and processing the incoming XML packets for the new query. Each XML query packet received is decrypted using a security methodology (described elsewhere, outside of this document). An XML-to-Java deserializer then converts FrameSlot objects (and other Java class objects encapsulated by the FrameSlot objects) into Java instances within the software module.

2. Data Mapping.

Vobots NLP's Semantra™ module ‘understands’ a user's request for information by mapping phrases in a sentence to ‘Subject Area Information Objects’ (common terms for ‘entities’ and ‘attributes’ of objects within a given subject area). The FrameSlot objects in the query packets contain Subject Area Information Objects (“Subject Area IOs”), as well as other optional query objects. SQL (Structured Query Language) comprises of SQL statements which refer to actual table names and column names of a targeted database. The Data Mapper maps Subject Area IOs to actual database tables and columns in the target database, so that the SQL code can be generated as needed.

One important point for mapping Subject Area IOs to actual database tables and columns in a target database lies in the utilization of ‘object hierarchies’. The actual tables and columns within a target database were linked to parent Information Objects when the database was originally ‘vocalized.’ This hierarchical object mapping was captured in Semantra™'s meta-repository at that time, along with the new Subject Area IOs. During the data mapping process, the Data Mapper consults the Semantra™ meta-repository data structures to find linkages, through the Information Object parentage hierarchy, to map given Subject Area IOs to database tables and columns. One design point to note is that query objects sent to the Data mapping module only contain sufficient information to construct SQL “select clauses” and “where clauses”. The SQL Generator constructs SQL statements from the table names and column names passed to it from the Data Mapper.

3. SOL Generation and Execution.

Vobots NLP SQL queries are ‘dynamically generated’ and then executed against targeted databases. Dynamic SQL Generation is achieved by first mapping Subject Area IOs from FrameSlot objects to true database table names and column names (as stated above, effectively constructing the ‘Select’ and ‘where’ clauses of an SQL statement). The SQL Generator constructs the SQL query statement, using the table names and column names passed to it by the Data Mapper and calling relational navigation algorithms (described below). These algorithms determine the ‘from’ clause, the ‘join’ clause and other clauses, such as Group By, Order By, Having, and ‘top n’, for example.

An important design advantage accrues from the distributed nature of Vobots NLP's natural language query system: by placing the SQL Generator at each customer site, this software module uses metadata knowledge about the type of RDBMS to construct the proper dialect of SQL to run against targeted databases at that customer site. One task for the SQL Generator is to determine the proper join clause for the SQL statement. The ‘from clause’ of an SQL statement names the tables ‘to be joined together’ in the query, while a ‘join clause’ stipulates how the table are to be joined, by naming the join-columns and the relational operator by which these tables are to be joined. An example SQL statement, showing the ‘from’ and ‘join’ clauses in bold, follows:
“select a.employeeName, b.deptName from Employee a inner join Department b on a.deptNO=b.deptNo”

Often an SQL query needs several intermediate ‘from tables’ and ‘join statements’, to be able to ‘navigate’ between tables mentioned in a select clause and/or where clause. Say a user request was “show me the Southwest employees”. The following SQL statement will get this answer:
“select a.employeeName from Employee a inner join Department b on a.deptNO=b.deptNo inner join Region c on b.regionID=c.regionID where c.regionName=‘Southwest’”

In this example, the only tables mentioned in the 'select‘and ‘where’ clauses were Employee and Region, but to ‘navigate’ between these tables the Department table had to be joined. Two relational navigation algorithms are known as the ‘V-rule’ and the ‘W-rule’. These algorithms provide the means by which Vobots NLP can a) decouple the NLU from the SQL Generator, and b) automatically construct SQL queries with little or no further human (user or analyst) intervention. These algorithms are explained below.

a. The V-Rule.

The V-rule, states that
for every instance a of Entity A that has a one-to-many (1:M) relationship to Entity A_{L}, for any level L of such relationships down to Level l, an instance l of Entity A_{L} will always have a direct or inferred 1:1 relationship with a.

This V-rule holds true because, in relational databases, any instance of Entity A is identified uniquely by the value of its Primary Key pk(A). And any Entity B related to Entity A will have a non-null value in its Foreign Key field(s) exactly equal to the value in pk(A). Entity relationships are binary’ in relational databases. A relationship between two entities has a cardinality at both ends of the relationship, and by convention, a 1:M relationship means that for every instance of Entity A there may be one or more instances of Entity B (note: a 0:M relationship would mean that there may be zero, one or more instances of Entity B for each instance of Entity A). Conversely, from the perspective of Entity B relative to Entity A, there is always one and only one instance of Entity A for each instance of Entity B (note: if the relationship is ‘optional’ then, if there is a non-null value of the join field (foreign key field) in Entity B with respect to Entity A, there is only one instance of Entity A for each instance of Entity B).

So if Entity A has a 1:M relationship with Entity B, and Entity B has a 1:M relationship with Entity C, and so forth down to Entity L, then according to the V-rule the instance value of Entity A's primary key will always be determinate for each instance of Entity L. The V-rule is named after the effect of viewing a set of entities related 1:M ‘downwards’ (with the parent entity as a box above the child entity). Since some entities have more than one parent entity, there will be a ‘V’ effect at each such child entity. The V-rule is really the theoretical basis for the language SQL. All result sets of an SQL query against a relational database return a ‘relation’—in effect a single table of rows (result instances).

A result set relation table (usually) maps logically to the lowest ‘common denominator’ table participating in the query: this ‘V-table’ is the table at which the ‘V’ points back up to all directly and indirectly parented tables participating in the query. The columns of the result set table of the query may be values in any entity table which is a 1:M parent (or a parent of a parent, for example); however, since the V-rule dictates that all such relationships were 1:1 ‘looking back up’ from the result set table, these column values are in effect single-value attribute values of the result set table. (Note: if any M:M relationships are involved in tables participating in a query, they are in effect made 1:M relationships by the ‘distinct’ word in the SQL statement; otherwise the result set is a Cartesian product which is generally nonsensical to the user). Within Vobots NLP, the V-rule is the guiding design principle for algorithms, which provides the means of automatically and dynamically completing an SQL query to extract data from targeted databases.

b. The W-Rule.

In databases of moderate size, queries can be generated successfully by the Vobots Data Mapper/SQL Generator through the employment of the V-rule. However, queries against databases with large numbers of tables often must invoke a second navigational algorithm, the W-rule algorithm. The W-rule algorithm is an extension of the V-rule algorithm. Similar to the V-rule, the W-rule can be visually pictured as having parent entities with 1:M relationships with multiple child entities. In the V-rule, a single query cannot have any participating tables which ‘break’ the V-rule; all tables must form a single ‘V’ going upwards from the V-table. But in the W-rule, essentially all tables are candidate participants in the query: the ‘W’ is really a shorthand name for ‘multiple Vs’. The Vobots SQL Generator automatically adds the ‘distinct’ adjective to the select clause of queries which invoke the W-rule.

4. Query Result Set Serialization, Encryption and Dispatch.

After the Data Mapper successfully maps incoming Subject Area IOs to actual database table names and column names, and after the SQL Generator successfully generates an SQL query, this query is executed against the target database, returning result sets for the query. Result sets (answer sets) of an SQL query are serialized into XML packets. These XML packets are encrypted and sent back to the Vobots Request Manager/Router module. If the result sets are larger than a size predetermined by business rules set by the Vobots Request Manager, result sets are ‘batched’ and a persistent session is set up between the Dispatcher thread and the Request Manager/Router.

The Request Manager Router routes result sets through the Vobots Answer Set Formatter (described in a separate document) to the user. A user normally receives an answer ‘one result set at a time’; however, in certain cases the Request Manager may perform ‘post-processing’ functions (e.g., sorting) on answer sets, in which case all batches are accumulated at the Request Manager before being forwarded on to the user. In any case, batches are sent asynchronously via a handshaking set of transmissions until the batch of result sets is exhausted, or until the Request Manager/Router terminates the session.

Summary

The Vobots Data Mapper and SQL Generator module acts both as a software agent and as a functional software module. It normally resides at a client customer site location where one or more targeted corporate databases are housed.

4. Request Manager/Router

Overview.

Vobots NLP is a ‘round-trip request handling’ product, comprising of several modules. These Vobots NLP modules deduce the meaning of a natural language request or command, and either retrieve an answer or carry out a transaction in behalf of a requester. In its most common usage, Vobots NLP converts a request for information into SQL queries, which extract answers from public or private databases. Then another Vobots NLP software module formats and returns the answer to the requester. The software modules which comprise the functionality of Vobots NLP are:
Vobots Semantra™ (Natural Language Understanding Engine)
Vobots Request Manager/Router
Vobots Data Mapper/SQL Generator software agent
Vobots Answer Set Formatter

Object flow between Vobots NLP software processes are illustrated below, where objects in transit are shown underlined and processes are shown in bold font:
User request→Semantra™ NLU Engine→request query packets→Vobots Request Manager/Router→request query packets→Vobots Data Mapper/SQL Generator→answer sets→Vobots Request Manager/Router→answer sets→Vobots Answer Set Formatter→formatted answers→User device
   Request Manager/Router Functional Description.

The Vobots Request Manager/Router is the software module which manages all network routing, scheduling, marshalling and other management functions on XML packets containing Vobots ‘Requests’ and ‘Answer-Sets’, collectively called “Vobots Object Packets”. This document describes the functionality of the Vobots Request Manager/Router software module. The Request Manager/Router comprises five modules, each with a separate function:
a) Vobots Message Manager
b) Vobots Message Router
c) Answer-Set Processor
d) Request Multicaster
e) Request Component Aggregator

Each of these four functional modules is described below.

a) Vobots Message Manager.

The Vobots Message Manager is the module which oversees and keeps track of the entire flow of Messages throughout the ‘life cycle’ of a Request and its resultant Answer-Sets. The Message Manager maintains a list of client customer sites, along with other information (e.g., the target databases at each customer site, the Database type of each target database, the particular subject areas applicable for each target database, specific routing rules and instructions, and encrypted user IDs and passwords, for example). This information is refreshed whenever data elements change in value.

The Vobots Semantra™ NLU Engine sends a new Request (set of packets) to the Vobots Request Manager/Router, which invokes its Message Manager. The Message Manager module determines which target databases to send a Vobots Request message. At each client customer site, a Vobots Data Mapper/SQL Generator software agent is listening for incoming Requests, and retrieves the answer sets from that site's target database(s). The answer set packets are returned to the Vobots Request Manager/Router, which then routes the answer sets on to the Vobots Answer Set Formatter module. The Vobots Message Manager module calls upon the Vobots Message Router module to actually control the physical message routing and transmission, as well as protocol handshaking.

b) Vobots Message Router

The Vobots Message Router controls the transmission of Vobots Object Packets over a network: either over the internet or over a Virtual Private Network (VPN) as a set of messages. The Vobots Message Router module registers and logs each new message when it arrives from the Vobots Message Manager. From this time until the message has either been received or terminated, the Vobots Message Router is responsible for controlling all message transmission services and functions.

The invention follows open standard protocols and services for its message management wherever possible, including some or all of these specific areas of message management and web services:
XML (Extended Markup Language)
SOAP (Simple Object Access Protocol)
   WSDL (Web Service Description Language)
JMS (Java Messaging Services)

The invention preferably encapsulates any or all of the tools which support the protocols listed above inside its Message Router. Therefore, the other Vobots Request Manager/Router modules are isolated from (i.e., operate at a higher level to) the Message Router functions). By having its Message Router functions comply with industry standards for internet message handling and web services, a user can purchase or license this functionality and concentrate its development efforts on the other Vobots Request Manager/Router modules.

c) Answer-Set Processor

When a Request's Answer-Set is returned to the Vobots Request Manager/Router from the Vobots Data Mapper/SQL Generator, the Answer-Set Processor routine is invoked. This module performs any ‘post-process’ actions upon answer-sets, including sorting, restriction of answer-sets (i.e., ‘top n’ answers in alphabetic order). This module consults business rules handed to it from the Vobots Message Manager when the first Request packet was received, coupled with other factors such as number of answer-set rows, for example, sent to it from the Vobots Data Mapper//SQL Generator.

d) Request Multicaster.

One of the invention's advantages resulting from its Vobots NLP distributed architecture is the ability to ‘multicast’ natural language information requests. A Vobots Request Multicaster module and functionality is described below. When the Message Manager module registers a Request, it determines the Request's target databases and client customer sites from which to extract answers. If the Request was routed to more than one target database, and if the Request is monolithic (i.e., not made up of ‘request components’—discussed below in the Request Component Aggregator section), then the Request Multicaster module is invoked. Multicasting a request simply means simultaneously sending the same request to several disparate data sources which may independently supply the answer to the single request. The Request Multicaster collects the answers-sets from the different target databases when they are returned to the Message Manager, and before they are sent to the Answer-Set Processor. This module is asynchronous by its nature: it may wait a predetermined amount of time to collect all answer-sets from the target databases to which the request was multicast.

e) Request Component Aggregator

Another novel feature of the Vobots NLP distributed architecture is the capability of breaking a single Request query into ‘component queries’, which are sent to disparate data sources. This feature is akin to the Request Multicaster module described above; however, it differs in that its responsibility is to collect and aggregate the request components from the disparate data sources, and then to synthesize the results of the component answer-sets into a final answer-set. An example of a Request which is segmented into components is shown below.

Say that the user's information request is “What is the average number of miles our employees have to travel to our customer sites?” This request is segmented into two components, one of which is sent to the company's Sales and Customer System and the other is sent to the company's Human Resources System. The component query sent to the Human Resources System is “Send the employee ID, name and location coordinates of each of our sales employees”, and the component query sent to the Sales and Customer System is “Send the name, location coordinates, and assigned sales employee of Customers”.

The Request Component Aggregator dispatches these component queries through the Message Manager module, and waits for the answer-sets to be returned. Then the module performs aggregation functions to merge the two answer-sets into a single answer. In this example the Request Component Aggregator joins the component query answer-sets into a single resultant answer-set. The module invokes the ‘average’ function over a ‘geographic distance’ calculation function, sending it as parameters the latitude and longitude of each Customer Site for each Employee (Sales Employee) row. One novel (and perhaps patentable) feature of the overall Vobots NLP architecture is shown in the example above: the use of Natural Language in sub-queries constructed by the software modules themselves. This novel use of Natural Language greatly simplifies the automation tasks within the Vobots NLP product: its software modules process NL queries without knowledge or regard of whether a human asked the question or a software module or agent.

Summary

The Request Manager/Router serves as the ‘traffic cop’ for Requests sent from the Vobots Semantra™ NLU Engine, and as the ‘answer-set processor’ for handling the query result sets (Answer-Sets) fetched from target data sources in answering these Requests. As the traffic cop, the module calls on its Message Router module. The Message Router abstracts away from the application processes all protocol management and network traffic management, calling upon one standards such as SOAP and WSDL. In some cases, the Request Manager/Router software module performs specialized functions (Request Multicasting and Request Component Aggregation) before the final Answer-Set Processing function.

→5. Answer Set Formatter

In the following description of one exemplary embodiment of the invention, the Vobots Semantra™ NLE parses the user information request (performed on the Vobots Application Server), and then decouples the rest of the process by sending parsed requests as encrypted XML packets to a Vobots Request Manager/Router (a completely separate software module from the Semantra™ NLE). This Vobots Request Manager/Router then routes the XML packets across the internet or Virtual Private Network to one or more Vobots Data Mapper/SQL Generator software agents, which usually reside on a computer physically housed at a customer's site where corporate databases maintain data needed to answer the user's information request. Multicasting a single User Information Request to disparate target data sources and synthesizing the answer subsets into a single answer.

An important feature of the Vobots NLP architecture (a feature described in Act 5 in the Act-by-Act sequence exhibits) is that a single user information request or command may be ‘multicast’ to more than one targeted database. In such case, the Vobots Request Manager/Router is alerted to watch for ‘candidate answer sets’ coming back from the targeted database sites; when all such answer sets arrive, this software module may perform post-processing functions according to pre-defined rules and conditions. Certain novel design features of this capability, including the ability to merge and synthesize answer sets from both vocal responses and data responses, are described above.

A. Vobot controlled Round-trip Request/Response

Overview

The Vobot is a bluetooth-enabled device designed for a sole, dedicated purpose: to be a user's ‘personalized vocal agent for the wireless web’. Embedded in the Vobot is a set of software modules from Vobots, Inc.'s Vobots Natural Language Processing (NLP) application. Included in the embedded Vobots NLP software is a Natural Language Understanding (NLU) software module. Together with other embedded software (voice recognition, speech-to-text), a Vobot quickly learns its user's voice and can ‘understand’ his or her vocal information requests or commands. The Vobot converts its user's natural language request or command into text, formatted as Short Message Service, or SMS. This SMS text message is sent out to other devices, or to destinations over the wireless web, where the information is retrieved or the command is carried out. When an answer comes back, the Vobot converts the text ‘answer-set’ back to voice and sends the answer to the user (through another embedded software module: Text-to-Speech). This document shows and explains the Act-by-Act ‘round-trip’ process initiated and controlled by the Vobot: for understanding a Vobot user's request or command by voice, processing the request or command, and returning the answer to the request or command to the user.

Architecture of Basic Vobot Design

In the basic Vobot architecture, the Vobot is designed as a ‘neutral’ bluetooth device: one whose functions are basically limited to speech-oriented functions (Voice recognition speech-to-text, natural language understanding and text-to-speech). In this basic Vobot architecture, the Vobot communicates with other bluetooth devices (headset, cell-phone, PDA or PC) to achieve the round-trip functionality necessary to achieve the Vobot's main design goal. Among the functions supplied by other bluetooth-connected devices are a) voice input/output (microphone, speaker), b) text display, and c) menu bar/scroll buttons for scrolling through answer-set lists. The bluetooth devices set up to cooperatively achieve round-trip functionality are:
1. The Vobot
2. A bluetooth-enabled headset
3. A bluetooth-enabled ‘wireless web-connected’ device: a. Cell-phone, b. PDA, c. PC.

The bluetooth headset is ‘connected’ electronically to both the Vobot and to one or more wireless web-connected bluetooth devices: (cell-phone, PDA, PC).

Within the Vobot are embedded software modules:
Bluetooth Communications Controller.
Vobots NLP
Semantra™ Natural Language Understanding (NLU) Engine
   Terminology lexicon
   Semantra™ Semantics Knowledgebase
   Successful Previous Requests
Speech-to-text (STT)
Voice recognition (VR)
Text-to-speech (TTS)

Within the bluetooth devices (cell-phone, PDA, PC) are the normal functions associated with each type of device (cell-phone: speaker, microphone, number pad, display, menu pad, scroll buttons, wireless connection); PDA: graffiti writer, display, buttons, menu pad, scroll buttons, optional wireless connection. At least one of these other bluetooth devices must have a wireless connection to the ‘wireless web’, so that the Vobot can send a text message to external data sources to fetch and return an answer to the user's vocal request or command.

Act-by-Act ‘Round-Trip’ Request/Response Process.

Act A. Alternatively Routing Voice Calls Directly Between the Headset and Cell-Phone.

The user will normally use the same bluetooth headset both for Vobot-initiated requests or commands and for common telephone conversations. When the headset is used for a phone conversation, the Vobot's Bluetooth Communications Controller is sent an initial message from the headset to ignore the ensuing stream of vocal impulses (which may be a set of pulses from the cell-phone as the user punches in a telephone number to call, or alternatively a canned message), until future notification.

Act B. Initiating a Vobot Request or Command.

If the first voice message identifies the ensuing stream of voice impulses as phonemes for a Vobot request or command, the Vobot's Bluetooth Communications Center sets up a session with the Vobot to stream the phonemes to the voice recognition module and also to the speech-to-text module. The voice recognition (VR) module ‘listens’ to a sufficient number of phonemes that enable it to determine if the speaker is indeed the bona-fide, registered Vobot user. If this authentication is passed, the VR module signals the Bluetooth Communications Center that the user is authentic, and no more phonemes are streamed to the VR for the remainder of the request session. If the VR module cannot authenticate the user by voice, the Bluetooth Communications Center is notified, and actions are engaged to inform the user of this fact. The request session is then shut down. The Acts described below follow the ‘round-trip’ process of receiving a vocal request or command, through all the Acts to and including the return of the answer to the user.

Act B.1. Accepting the user's Vocal Request or Command.

The user's voice phonemes are streamed to the speech-to-text (STT) module, which converts the phonemes into words. The Vobot includes embedded Vobots NLP, including the Semantra™ NLU and three ‘extra’ databases which can be consulted by the STT module: a Terminology Lexicon (for morphology functions, such as past/present tense), the Semantics Knowledgebase and a database of ‘successful previous requests’.

After the STT module has converted each spoken word into text, the text message is handed to the embedded Semantra™ NLU module, which attempts to place the words and phrases in a context ‘known’ to its Semantics Knowledgebase and/or Successful Previous Requests. Note: The STT and NLU modules can ‘iterate’ and aid each other in disambiguating words and phrases. This ‘extra Act’ of context dependent word recognition is a tremendous advantage for wireless communication, since the very disambiguation of spoken words by the STT can be greatly improved by the availability of a rich set of context-dependent words and phrases.

Act B.2. Prompting the User to ‘Confirm’ the Request Interpretation.

If the STT and/or NLU is uncertain of its request interpretation, the user is prompted to confirm not only of the actual words used, but the meaning of non-recognized words in a context known to Semantra™'s NLU. In cases where there are ‘candidate words’ between which the NLU cannot choose with confidence, the user can be presented these choices to select from (either verbally and/or visually, through the appropriate device's display).

Act B.3. Sending the Converted SMS Request Message ‘to the External World’.

Since the basic Vobot design is as a ‘neutral’ device having no built-in wireless-web connectivity, the Vobot must rely on an interdependent bluetooth device for a connection to the ‘wireless web’. The converted SMS request is sent through the wireless web-connected bluetooth device out to the ‘external world’ for processing and/or fetching answers.

Act B.4. SMS Text Request Sent to Vobots Application Server.

The SMS text request message is sent to the Vobots application server, which hosts the Vobots NLP application. This application accepts the text message just as if it were typed by a user in a textbox on a web browser. In addition to the text message itself, other text instructions tell the Vobots NLP that this message is from a wireless device user's Vobot, so that it can set up appropriate actions. The Semantra™ NLU usually is bypassed for a Vobot-initiated text request, since the embedded version of the Semantra™ NLU has already ‘understood’ the request. The request is converted into an encrypted set of XML packets and sent to the other cooperative Vobots NLP modules to fetch the answer-set(s) for the request.

Act B.5. Answer Set Encrypted and Sent to the Vobots Answer-Set Formatter.

The answer-set is repackaged and encrypted into XML packets and sent to the Vobots Answer-set Formatter.

Act B.6. Formatting the Answer-Set for the Destination Wireless Device.

The Vobots Answer-set Formatter normally determines what type of device the answer-set is being sent to, and formats the answer-set accordingly. In the case of a Vobot-initiated text request, the answer-set formatting is left to an equivalent Answer-set formatting module in the Vobot itself.

Act B.7a. Displaying the Answer-Set on a Device Display.

If the answer-set is formatted as a displayable set of rows on the destination wireless device's display, the user is notified that the request's answer is now ready to be shown on the device display. The user can scroll up and down through the answer-set rows and give further instructions (such as to save the answer-set as an email or on the PDA). From the display, if the answer-set offers a choice to the user, he or she can choose the selected option and have a command carried out directly back through the wireless web, in effect starting a new message. If this option is taken, the Vobot is notified of the new action, and the selection text criteria and information is sent to Vobots as a new command. As an example, say that a list of the ‘five closest Italian restaurants’ is shown to the user. If the user wants to initiate a web service transaction to reserve a table at the chosen restaurant, this web service command can be initiated immediately through the PDA to the Vobot.

Act B.7b. Answer-Set Sent to the Vobot for Processing.

If the answer-set for a request requires a voice response back to the user, the SMS text response message is sent back to the Vobot, where the TTS module converts the answer to voice. Even if the answer has been finalized as a display-only answer set, the Vobot is notified so that the request and its answer-set can be logged as a ‘successful previous request’ for assistance in future NLU and STT processing.

Act B.8. Sending the Answer Back as a Voice Response to the User.

Unless the user's request answer-set has been sent as a ‘display-only’ answer on his or her wireless device, the final leg of the ‘round-trip’ request/response process is to send the answer back to the user as a converted TTS voice message, through the bluetooth headset.

Summary

In one embodiment the Vobot is a bluetooth-enable device which is designed to be a user's ‘personal vocalized agent for the wireless web’. The sequence of events in a round-trip request/response process involve cooperation between different functional modules, which are distributed between functions carried out on the Vobot device, functions carried out on other bluetooth-connected devices carried by the user, and functions carried out in web-server based applications.

6. The Vobot Embedded NL Product

Overview

The Vobot is a bluetooth-enabled device designed for a sole, dedicated purpose: to be a user's ‘personalized vocal agent for the wireless web’. Embedded in the Vobot is a set of software modules from Vobots, Inc.'s Vobots Natural Language Processing (NLP) application. Included in the embedded Vobots NLP software is a Natural Language Understanding (NLU) software module. Together with other embedded software (voice recognition, speech-to-text), a Vobot quickly learns its user's voice and can ‘understand’ his or her vocal information requests or commands. The Vobot converts its user's natural language request or command into text, formatted as Short Message Service, or SMS. This SMS text message is sent out to other devices, or to destinations over the wireless web, where the information is retrieved or the command is carried out. When an answer comes back, the Vobot converts the text ‘answer-set’ back to voice and sends the answer to the user (through another embedded software module: Text-to-Speech). The Vobot embeds all of the speech-related functions, including an NLU module, into a device which is smaller than a PDA. Thus the device's designers at Vobbts, Inc. have managed to solve one of the most vexing problem facing the wireless web: how to understand a full sentence spoken on a wireless device.

Uses of the Vobot.

In the future, speaking in normal, natural language will be the preferred way for people to ask for data and information over a cell-phone, PDA and perhaps even a personal computer. On cell-phones, users will no longer need to punch tiny buttons to spell out text messages. Even on a PC, a person can enter more words per minute by speaking than by typing. For personal use, people will use their Vobots to get all sorts of information over a cell-phone, from “what time does the sun go down tonight?”, to “what is the nearest theater showing a Western action movie?”, to “order a sausage and pepperoni pizza from the Pizza Hut and have it delivered to my home tonight at 7 PM”. Business executives can get quick information from their company databases. Example: “what were our OEM sales for last quarter”? Business travelers can request information such as, “Show me the flights from DFW to Oakland leaving tomorrow after 3 PM that cost under $500”, or “show me the five lowest priced hotel rooms available tonight within ten miles of the Oakland airport”.

A user can request information that resides on his or her PDA (e.g., “bring up the name of the guy who works for IBM and lives in Arlington.”), and the person's address book information pops up on the PDA display. Users can also get information from other bluetooth-enabled devices including a PC: “Go to my Office computer and zip up the latest version of the Sales Report and email it to Bob Smith and Jim Jones.”

Hardware and Software Components of the Vobot Device.

The most basic configuration of the Vobot device is as a dedicated vocal assistant, without other functionality found on cell-phones or PDAs. In this ‘neutral’ configuration, the Vobot relies on other bluetooth-enabled devices to carry out certain request/response functions.

Round-Trip Request/Response Functions Performed by the Vobot, Together with other Cooperative Devices and Wireless Web Applications.

The Act-by-Act process by which a Vobot takes in its user's spoken request or command, cooperates with other wireless devices and web services applications to carry out the request or command, and return the answer to its user by voice, is called the ‘round-trip request/response’ process in this document. The functions necessary to carry out this process are called the ‘round-trip functions’. The Vobot performs only some of the round-trip functions necessary to issue and then satisfy a user's spoken natural language request or command. Other functions within the round-trip process are carried out by ‘cooperative’ bluetooth-enabled wireless devices, or by ‘wireless web’ applications. The full list of the ‘round-trip functions’ needed to satisfy a user's spoken request or command is shown below:
a. Voice recognition
b. Speech-to-text conversion of a spoken request or command
c. Natural language understanding (NLU) of the request or command
d. Sending the converted request as an SMS text message over the wireless web
e. Converting the natural language request into database queries and extracting the desired information
f. Logging the sent request and setting up an alert for returning answer
g. Receiving and converting a text answer-set to desired format:
   Text display (e.g., PDA display)
   voice (Text-to-speech)
h. Sending the answer in spoken form to the user.

Below is a brief explanation of each of the round-trip request/response functions listed above.

a. Voice Recognition.

The Vobot has a built-in Voice Recognition (VR) software module, which can identify the Vobot's main user by his or her voice after some training. This function is essential for security purposes. Before any request issued by the user is processed by the Vobot, the VR module verifies the authenticity of the user.

b. Speech to Text Conversion of a Spoken Request or Command.

The Vobot includes embedded software for Speech-to-text (STT). Since the Vobot is designed to be the personal vocalized agent of a ‘main user’, the STT unit is a ‘speech dependent’ type of STT (or sometimes called ASR—Automated Speech Recognition). This module is supplied by a third-party vendor (e.g., IBM's VIA Voice).

c. Natural Language Understanding (NLU) of the Request or Command.

The Vobot's built-in NLU translates text requests into a format suitable to retrieve information from external data sources. The embedded NLU is a mobile-device version of the Semantra™ NLU Engine (one of the cooperative software modules within the company's Vobots NLP application). The NLU engine is fully functional, but is limited (pared down) to predetermined subject areas contained in the embedded Vobots NLP databases. The embedded Semantra™ NLU engine consults three databases to help interpret the user's vocal request or command:
A Terminology lexicon (a database of words for determining past/present-tense and singular/plural word forms (morphology)
Semantra™'s Semantic Knowledgebase of semantic phrases and subject area terms
A list of ‘successful previous requests’

Note: This feature of the Vobot technology—making available to the speech-to-text and voice recognition modules and databases: a terminology lexicon, a subject area knowledgebase and a list of successful previous requests, can yield greater interpretation accuracy over simpler STT products.

d. Sending the Converted Request as an SMS Text Message over the Wireless Web.

The STT module converts the vocal request or command to an SMS text message. Since the Vobot has no wireless connection to the wireless web or to other outside data sources, it sends this SMS text message ‘through’ another bluetooth device (e.g., a cell-phone or PDA) out to the ‘wireless web’. The most common destination of the SMS text message is Vobots, Inc.'s web portal, where the company's Vobots NLP application exists. In the case where the SMS text message is a command set, not an information request, alternative functional routes are taken which bypass the Vobots NLP's Semantra™ NLU Engine.

e. Converting the Natural Language Request into Database Queries, Extracting Desired Information.

When a Vobot's user asks for information which resides in external data sources (e.g., corporate or public databases), the SMS text message is routed out through the ‘wireless web’ to the Vobots NLP application,which is set up to handle text requests and commands. Here, the SMS text message is treated in the usual manner for handling request/response functions by the Vobots NLP. The Vobots NLP is a complete ‘round-trip’ set of functions for receiving text-based requests for information. It includes the same Semantra™ NLU Engine as is embedded in the Vobot (although in more robust form, capable of handling many subject areas). When a Vobot text request is sent to Vobots NLP, the Semantra™ NLU engine itself is usually bypassed (the message has already been ‘understood’ by the Vobot's embeeded version of Semantra™ NLU); however, all of the other distributed functions within Vobots NLP are performed on the request. The Vobots NLP architecture is distributed such that some of its software modules reside at ‘target databases’ for a particular request; this software agent dynamically creates SQL queries and executes them on the target databases, thus capturing the desired information as a set of query result-sets (‘answer-sets’).

f. Logging the Sent Request and Setting up an Alert for Returning Answer.

The Vobot's Communications Controller contains all bluetooth connection logic, and also has methods for logging and keeping track of SMS messages. When a new request message is sent out, the request is logged and alerts are set up for monitoring the time the request is ‘outstanding’ (e.g., until the response message is returned). The Vobot's user can ask about the status of outstanding requests. The Vobots NLP technology allows users to set conditions, such as a stock price point, which will trigger a returned message to the user.

g. Receiving and Converting a Text Answer-Set to Desired Format(s).

All response messages are returned as SMS text messages. Depending on pre-determined rules set by a Vobot's user, the answer-set is directed to one (or more) of the user's bluetooth-enabled personal devices (e.g., cell-phone, PDA, PC). Vobots NLP technology includes an ‘Answer-set formatter’ module, which is utilizes an XML parser coupled with an XSLT formatter to format a response answer-set to the appropriate device.

The Vobot includes rules-based logic for determining the destination of a response message. This rules-based module looks at several factors, including the number of rows in an answer-set, whether or not a selection is needed by the user, for example. For example, if the user wants an answer to a simple question (e.g., “what is next Monday's date?”), the answer set is converted back to speech (see next section) and sent back to the user as a voice message.

In another example, the response answer-set may be several rows, for a question like “show me the closest five three-star Italian restaurants”. In this example, the Answer-set formatter may send the answer set to the user's PDA, where the user can menu through the answer set on the PDA display with the menu scroll buttons. In some cases, an answer set is sent to more than one bluetooth-enabled device. For instance, the user may want to ‘log’ every incoming response on his or her PDA, regardless of whether the answer was directed back as a voice response to the user.

h. Sending the Answer in Spoken Form to the User.

If the response to a user's voice request is to be sent back to the user as a voice message, the Vobot's text-to-speech (TTS) module is invoked. The TTS module is a third-party product (e.g., Lucent Technologies' Bell Labs Text-to-Speech Synthesis product).

Alternative Vobot Designs and Configurations.

The Vobot device design described herein is as a ‘neutral’ device, dedicated solely to converting a request or command from speech to text, understanding the full sentence's context (natural language understanding), sending the SMS text message to the ‘outside world’ to be processed, and finally capturing the answer to the response in text and directing the answer set to the appropriate user device. Alternative design configurations may include:
Embedding the Vobot functions inside a PDA
Including a headset interface inside the Vobot (rather than interfacing with a bluetooth-enabled headset)
Including a display and set of scroll buttons inside the Vobot
   Summary.

The Vobot is designed to be a user's ‘personalized vocal agent for the wireless web’. Achieving this goal, the Vobot will be the user's most commonly used communications device, for all natural language interface to any wireless device, as well as to the wireless web. In one embodiment, the Vobot is a bluetooth-enabled device which has embedded in it ALL of the speech-handling functionality for ‘understanding’ vocal requests for information and commands over a cell-phone: voice recognition (VR), speech-to-text (STT) and natural language understanding (NLU). In addition, the Vobots has built-in text-to-speech (TTS) for sending back answers to its user in voice format. The Vobot is designed to work in combination with other bluetooth-enabled devices, such as a headset, cell-phone, PDA, and PC, to perform the ‘round-trip’ functionality necessary to satisfy a user's requests for information or commands.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application. It is therefore the intention that the appended claims and their equivalents be interpreted as broadly as possible in view of the prior art to include all such variations and modifications.

1. A method of enabling a target data source to be queried by natural language searching, the method comprising the sequential acts of:
capturing metadata associated with a target data source, the metadata defining a target concept model; and
processing the target concept model to enable database searching through user queries stated in natural language.

2. The method of claim 1 further comprising reporting an answer, the answer extracted from the target data source.

3. The method of claim 2 wherein the target concept model comprises entities, each entity being logically mapped to a table in a target data source, and each entity comprising at least one attribute, each attribute being logically mapped to one column in the table.

4. The method of claim 3 further comprising defining a logical relationship between a pair of entities in the target concept model based on metadata.

5. The method of claim 1 wherein the target concept model is defined as a subject area, the subject area comprising one or more logical views, the logical view comprising at least two entities.

6. The method of claim 3 wherein a pair of entities are linked based upon one of the following relationships: an ‘is-a’ logical relationship, a ‘has-a’ logical relationship, or a ‘member-of’ logical relationship.

7. The method of claim 3 wherein each concept entity and each concept attribute is assigned a natural language name.

8. The method of claim 1 wherein processing comprises generating a semantic phrase that associates at least two entities, and storing the semantic phrase in a semantic phrase repository.

9. The method of claim 8 wherein a second semantic phrase may be linked as a child phrase to a parent semantic phrase, the parent semantic phrase already existing in a semantic phrase repository.

10. The method of claim 1 wherein processing adds a new concept model layer to an existing concept model repository, and also adds at least one semantic phase to an existing semantic phrase repository, wherein the two repositories are interdependent.

11. The method of claim 10, wherein the two phrase repositories are structured and organized such that a natural language request for information from a target database can be interpreted by a natural language processor and automatically translated into a data query that returns a precise answer to a user.

12. The method of claim 1 further comprising defining a concept object based on conditions that make the concept object unique.

13. The method of claim 1 further comprising defining a new attribute as a logical equivalent of a predefined attribute associated with an entity.
